(19) United States
(12) Patent Application Publication
(10) Pub. No.: US 2014/0126034 A1
(43) Pub. Date: May 8, 2014

(54) VARIABLE SHAPE MIRROR AND METHOD OF MANUFACTURING THE SAME

(71) Applicant: Canon Kabushiki Kaisha, Tokyo (JP)

(72) Inventors: Hiroyuki Ozaki, Yokohama-shi (JP); Yasuhiro Shimada, Sagamihara-shi (JP); Koichiro Nakanishi, Tokyo (JP); Akira Shimazu, Hiratsuka-shi (JP); Kenji Tamamori, Ebina-shi (JP)

(73) Assignee: Canon Kabushiki Kaisha, Tokyo (JP)

(21) Appl. No.: 14/066,017

(22) Filed: Oct. 29, 2013

(30) Foreign Application Priority Data
Nov. 7, 2012 (JP) 2012-245862
Nov. 13, 2012 (JP) 2012-248937

(51) Int. Cl. G02B 26/08

(52) U.S. Cl. CPC G02B 26/0841
USPC 359/224.1; 29/829

(57) ABSTRACT

In the method of manufacturing a micro structure including a membrane in a first substrate, a movable portion, a movable comb electrode, a suppressing unit, a support portion, and a fixed comb electrode are formed, and the movable portion of the first substrate and a second substrate are bonded. Then, the bonded second substrate is processed to form a membrane such as a reflecting portion. The movable comb electrode is supported by the movable portion and extends in a direction parallel to the membrane surface. The suppressing unit suppresses displacement of the movable comb electrode and the movable portion in a direction other than a direction normal to the membrane surface. The fixed comb electrode is supported by the support portion and extends in the direction parallel to the membrane surface. The fixed comb electrode is alternately arranged with respect to the movable comb electrode with a gap therebetween.

### BACKGROUND OF THE INVENTION

1. Field of the Invention

The present invention relates to a variable shape mirror to be used as an adaptive optics wavefront correction device or the like, and a method of manufacturing the same.

2. Description of the Related Art

Hitherto, a variable shape mirror of a type to be displaced by an electrostatic attractive force is expected to be applied to various fields utilizing light. For example, the variable shape mirror can be utilized as an adaptive optics wavefront correction device to be installed in a fundus testing apparatus, an astronomical telescope, or the like. As a representative example of such a variable shape mirror that is displaced by an electrostatic attractive force, there is known a measure of enabling movement by using two parallel plate electrodes, but this parallel plate type has a disadvantage in that the moving amount is small.

Further, in recent years, a variable shape mirror that uses comb electrodes and can achieve a larger moving amount than that of the parallel plate type has been proposed. An example thereof is disclosed in U.S. Pat. No. 6,384,952. In the variable shape mirror, a support portion that supports a comb electrode on a movable side and a support portion that supports a comb electrode on a fixed side are respectively located on upper and lower sides in a perpendicular direction on the drawing sheet of the drawing of U.S. Pat. No. 6,384,952. The movable comb electrode and the fixed comb electrode are opposed to each other, and are arranged so as to be alternately arrayed with a gap. With this, an electrode overlapping area larger than that in the parallel plate type can be achieved. Therefore, a larger electrostatic attractive force can be generated between the comb electrodes, and thus a moving amount can be increased.

However, in the structure disclosed in U.S. Pat. No. 6,384,952, the fixed comb electrode and its support portion are arranged in a moving direction of the movable comb electrode. Therefore, an excessive electrostatic attractive force may act on the movable comb electrode as compared to a restoring force of a spring acting on the electrode. As a result, in some cases, the comb electrode on the movable side collides with the support portion on the fixed side, which corresponds to a phenomenon called pull-in. Therefore, with this structure, it is difficult to obtain a larger moving amount. Further, when a sacrificial layer process disclosed in U.S. Pat. No. 6,384,952 is used to manufacture this structure, the amount of the gap between the comb electrodes and the moving amount of the movable comb electrode are liable to be substantially equal to each other. Therefore, it is difficult to obtain a large moving amount while achieving a narrow gap that is required for obtaining a large electrostatic attractive force.

### SUMMARY OF THE INVENTION

In order to solve the above-mentioned problem, according to one aspect of the present invention, there is provided a method of manufacturing a variable shape mirror including: a reflecting portion including a reflecting surface; a movable portion connected to a rear surface of the reflecting portion; a movable comb electrode that is located with a distance with respect to the reflecting portion and supported by the movable portion, the movable comb electrode extending in a direction parallel to the reflecting surface; a suppressing unit for suppressing displacement of the movable comb electrode and the movable portion in a direction other than a direction normal to the reflecting surface; a support portion; and a fixed comb electrode that is supported by the support portion and extends in the direction parallel to the reflecting surface, the fixed comb electrode being alternately arranged with respect to the movable comb electrode with a gap therebetween, a part of the movable portion, which supports the movable comb electrode, and a part of the support portion, which supports the fixed comb electrode, being arranged such that the movable comb electrode and the fixed comb electrode pass each other while maintaining the gap when the movable comb electrode is displaced in the direction normal to the reflecting surface, the method including: forming, in a first substrate, the movable portion, the movable comb electrode, the suppressing unit, the support portion, and the fixed comb electrode; preparing a second substrate; bonding the movable portion of the first substrate and the second substrate to each other; and processing the bonded second substrate to form the reflecting portion.

Further, more generally, the present invention is applicable to a method of manufacturing a micro structure including a membrane. In this case, the reflecting portion is replaced by the membrane, and the reflecting surface is replaced by the surface of the membrane.

Further features of the present invention will become apparent from the following description of exemplary embodiments with reference to the attached drawings.

### BRIEF DESCRIPTION OF THE DRAWINGS

FIG. 1-1A is a plan view illustrating a variable shape mirror according to a first embodiment of the present invention, and FIGS. 1-1B, 1-1C, 1-1D and 1-1E are sectional views illustrating a method of manufacturing a variable shape mirror according to the first embodiment of the present invention.

FIGS. 1-2F, 1-2G, 1-2H, 1-2I and 1-2J are sectional views illustrating the method of manufacturing a variable shape mirror according to the first embodiment of the present invention.

FIG. 2-1A is a plan view illustrating a variable shape mirror according to a second embodiment of the present invention, and FIGS. 2-1B, 2-1C 2-1D and 2-1E are sectional views illustrating a method of manufacturing a variable shape mirror according to the second embodiment of the present invention.

FIGS. 2-2F, 2-2G, 2-2H, 2-2I, 2-2J and 2-2K are sectional views illustrating the method of manufacturing a variable shape mirror according to the second embodiment of the present invention.

FIG. 3A is a plan view illustrating the variable shape mirror according to the second embodiment of the present invention, and FIG. 3B is a sectional view thereof.

FIGS. 4A and 4B are sectional views of bumps formed in the method of manufacturing a variable shape mirror according to the second embodiment of the present invention.

### DESCRIPTION OF THE EMBODIMENTS

A manufacturing method of the present invention includes constructing a comb-drive actuator of a first substrate, the comb-drive actuator including a movable comb electrode and a fixed comb electrode that are alternately arranged with a gap therebetween, bonding the first substrate and a second substrate to each other, and processing the bonded second substrate to form a reflecting portion or a membrane. As one embodiment of the manufacturing method, there is a method of manufacturing a variable shape mirror including bonding a single second substrate on a movable portion of a single first substrate. In this case, when the movable portion is displaced, the reflecting portion is moved in parallel. Further, as another embodiment of the manufacturing method, there is a method of manufacturing a variable shape mirror including bonding a single common second substrate onto multiple movable portions of multiple first substrates arranged in an array. In this case, when the multiple movable portions are displaced in various modes, the single reflecting portion is displaced and moved in various modes. According to the manufacturing method as described above, it is easy to manufacture such a structure that, when the movable comb electrode is displaced with respect to the fixed comb electrode in a direction normal to a reflecting surface or a membrane surface, the movable comb electrode does not collide with other parts of the first substrate.

In the following, embodiments of the present invention are described with reference to the drawings. Note that, the present invention is not limited to the examples described below.

### First Embodiment

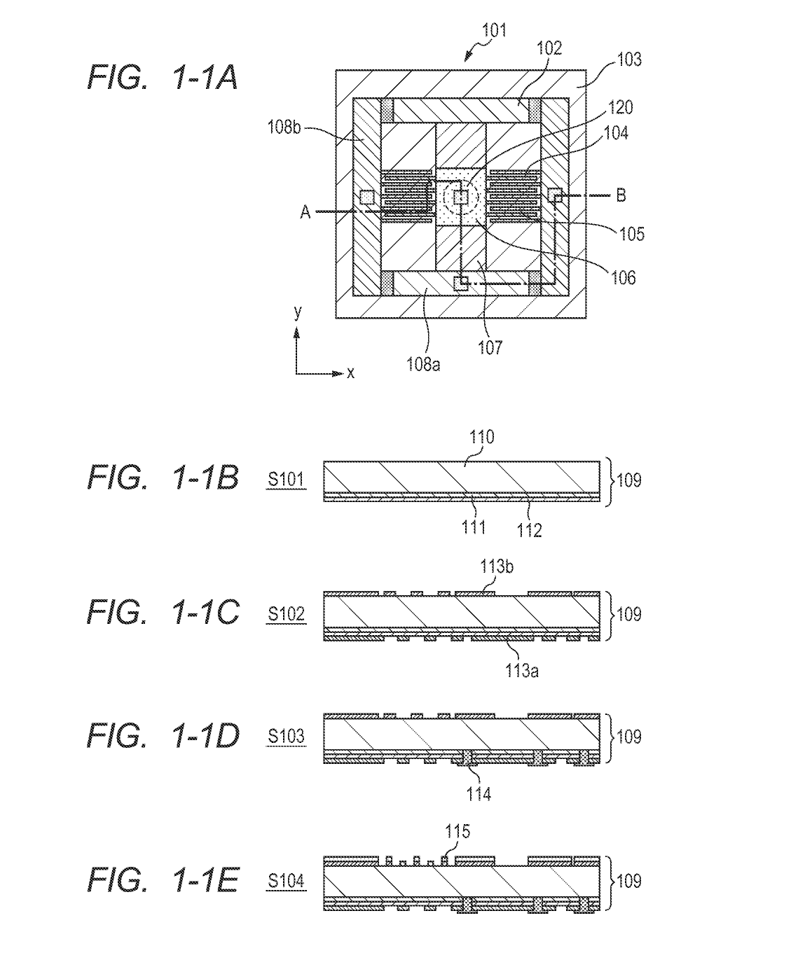

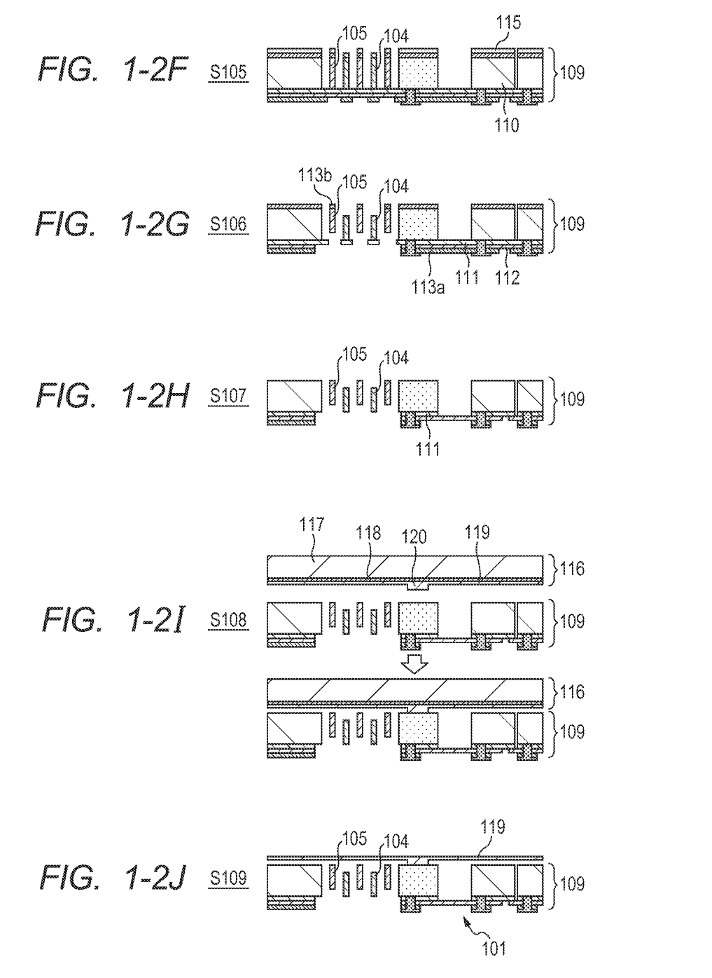

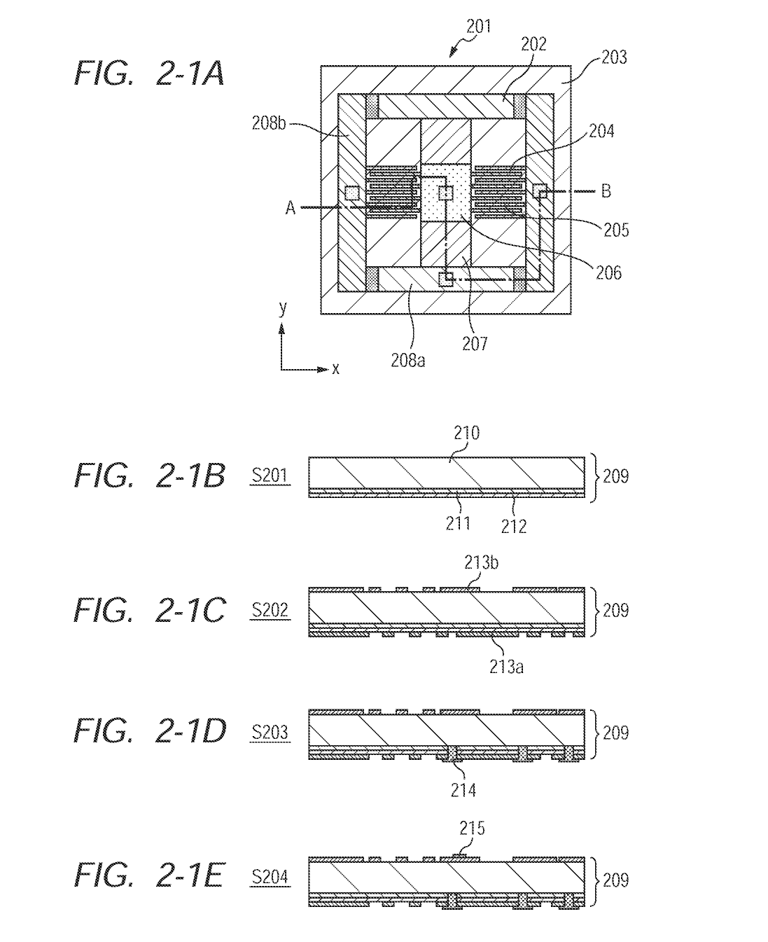

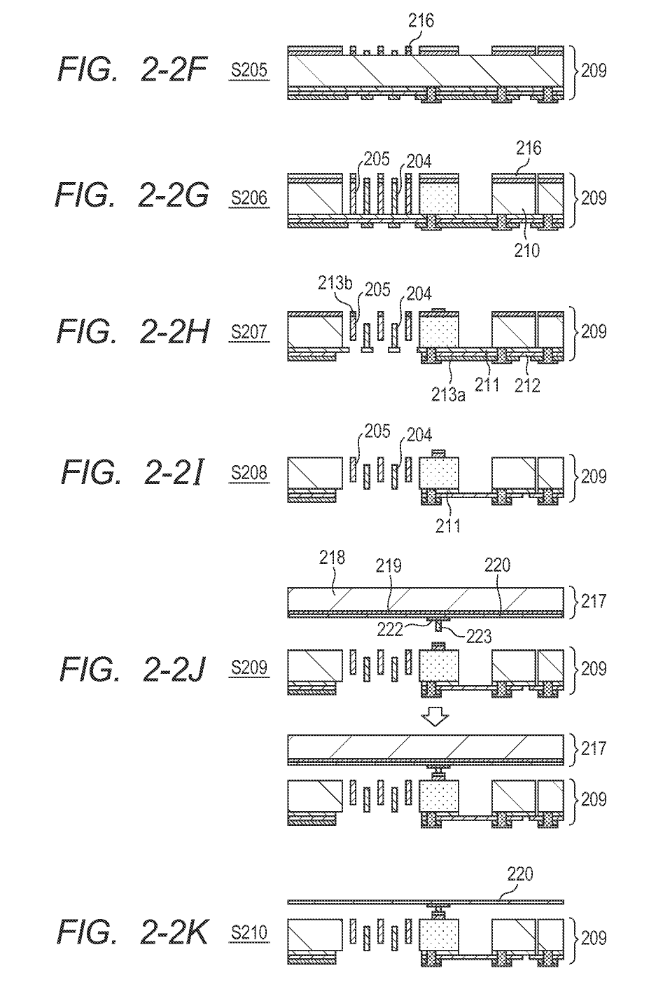

A method of manufacturing a variable shape mirror according to a first embodiment of the present invention is described with reference to FIGS. 1-1A to 1-1E and FIGS. 1-2F to 1-2J. FIG. 1-1A is a plan view of a variable shape mirror 101 as viewed from a rear surface of an actuator portion 102, and FIGS. 1-1B to 1-1E and FIGS. 1-2F to 1-2J illustrate manufacturing steps therefor by means of sectional views taken along the line A-B of FIG. 1-1A.

The variable shape mirror 101 to be manufactured includes the actuator portion 102 and a reflecting member 103. The reflecting member 103 has an optical reflecting function of reflecting light to be corrected. The reflecting member 103 has a reflecting surface for reflecting light. The reflecting member 103 covers the actuator portion 102 and is arranged so as to be opposed to upper surfaces of support members 108. Further, the actuator portion 102 includes a movable comb electrode 104, a fixed comb electrode 105, a movable member 106, two elastic members 107, and the support members 108 (108a and 108b). The movable member 106 is coupled to the elastic members 107, and is also connected to the movable comb electrode 104 and the reflecting member 103. One end of each of the elastic members 107 is fixed to the support member 108a. The movable comb electrode 104 is connected to a side wall of the movable member 106, and the reflecting member 103 is connected to the upper surface of the movable member 106, which has a relatively large area. That is, the upper surface of the movable member is connected to the surface of the reflecting member 103 on a side that is not used as the reflecting surface. The elastic members 107 are provided for limiting the movable range of the movable comb electrode 104 and the movable member 106. By increasing the width of the elastic members 107, the elastic members 107 function as a suppressing unit for allowing displacement in a direction normal to the surface of the support member 108 and for suppressing displacement in a direction other than the normal direction. Instead of increasing the width of the elastic members 107, at least three elastic members may be provided, or a protrusion perpendicular to the upper surface of the support member 108 may be provided around the movable member 106, to thereby limit the displacement of the movable member 106 in the direction other than the direction normal to the upper surface of the support member 108. The support member 108a electrically connected to the movable comb electrode 104 is insulated from the support member 108b electrically connected to the fixed comb electrode 105 with an insulating portion formed at a boundary portion therebetween.

The movable comb electrode 104 extends in an x direction from the side wall of the movable member 106 extending parallel to a yz plane, and the fixed comb electrode 105 extends in the x direction from a side wall of the support member 108b extending parallel to the yz plane. That is, the movable comb electrode 104 is located with a distance to the reflecting member 103, and is supported in a cantilever manner by the side wall of the movable member 106 to extend in a direction parallel to the upper surface of the support member 108. Further, the fixed comb electrode 105 is supported in a cantilever manner by the side wall of the support member 108b to extend in the direction parallel to the upper surface of the support member 108, and in addition, is alternately arranged with respect to the movable comb electrode 104 with a gap therebetween. The side walls of the movable member 106 and the support member 108 are opposed to each other, and hence the movable comb electrode 104 and the fixed comb electrode 105 are opposed to each other, and in addition, comb teeth thereof are arranged so as to be alternately arrayed. In other words, the side wall of the movable member, which supports the movable comb electrode, and the side wall of the support member, which supports the fixed comb electrode, are arranged such that, when the movable comb electrode is displaced in the direction normal to the surface of the support member, the movable comb electrode and the fixed comb electrode pass each other while maintaining the gap.

Next, a method of manufacturing a variable shape mirror is described.

First, as illustrated in FIG. 1-1B, a first substrate 109 is prepared (S101). The first substrate 109 is a silicon on insulator (SOI) substrate. The SOI substrate includes a handle layer (Si) 110 having a thickness of 525 μm, a buried oxide (Box) layer (SiO₂) 111 having a thickness of 1 μm, and an SOI layer (Si) 112 having a thickness of 1 μm.

Next, as illustrated in FIG. 1-1C, on both surfaces of the first substrate 109, patterns of insulating layers 113 (113a and 113b) are formed (S102). In this step, after silicon oxide (SiO₂) is formed by thermal oxidation as the insulating layers 113, resist patterns (not shown) are formed. With use of the resist patterns (not shown) as a mask, the insulating layers 113 are subjected to etching. For example, as the etching, plasma etching using a fluorocarbon gas such as tetrafluoromethane (CF₄), difluoromethane (CH₂F₂), and trifluoromethane (CHF₃) is employed. Those fluorocarbon gases may be used alone or mixed with other fluorocarbon gases, or may be used by being mixed with an inert gas such as argon (Ar) or helium (He).

Next, as illustrated in FIG. 1-1D, through electrodes 114 electrically connected to the respective support members 108 (108a and 108b) are formed (S103). A resist pattern (not shown) is formed on the rear surface of the first substrate 109. With use of the resist pattern (not shown) as a mask, the SOI layer (Si) 112 and the Box layer (SiO₂) 111 are subjected to etching to form through holes. Further, after films of titanium (Ti) and gold (Au) as electrode materials are laminated, a resist pattern (not shown) is formed. With use of the resist pattern (not shown) as a mask, gold (Au) and titanium (Ti) are subjected to etching.

Next, as illustrated in FIG. 1-1E, a mask for forming the comb shape is formed (S104). A resist pattern 115 is formed on the front surface of the first substrate 109, and the insulating layer 113b on the front surface of the first substrate 109 is subjected to etching. As for etching of the insulating layer 113b, plasma etching using a fluorocarbon gas exemplified in S102 is employed.

Next, as illustrated in FIG. 1-2F, the movable comb electrode 104 and the fixed comb electrode 105 are formed from the front surface of the first substrate 109 (S105). In this step, with use of the resist pattern 115 formed in S104 and the insulating layer 113b as a mask, the handle layer (Si) 110 is subjected to etching. In order to form the desired comb shape by subjecting the handle layer (Si) 110 to etching, for example, inductive coupled plasma-reactive ion etching (ICP-RIE) which enables etching with high verticality in cross section is employed. By employing ICP-RIE, a high-aspect and fine comb structure can be formed. In this step, a groove that becomes the insulating portion is also formed in the handle layer 110.

Next, as illustrated in FIG. 1-2G, level differences of the comb teeth are formed (S106). In order to form the level difference of the fixed comb electrode 105, with use of the insulating layer (SiO₂) 113a on the rear surface as a mask, the SOI layer (Si) 112 and the Box layer (SiO₂) 111 are subjected to etching. Further, silicon (Si) of the fixed comb electrode 105 is subjected to etching. Further, in order to form the level difference on the movable comb electrode 104 side, after the resist pattern 115 on the front surface and the resist pattern (not shown) on the rear surface are removed, with use of the insulating layer (SiO₂) 113b on the front surface as a mask, silicon (Si) of the movable comb electrode 104 is subjected to etching. As the etching of the silicon (Si) layer and the insulating layer, plasma etching using a fluorocarbon gas exemplified in S102, ICP-RIE exemplified in S104, or the like is employed. In this case, the first substrate 109 is subjected to etching to simultaneously form the fixed comb electrode 105 and the movable comb electrode 104. Then, between the fixed comb electrode 105 and the movable comb electrode 104, the level differences are formed in the direction normal to the surface of the handle layer 110.

Next, as illustrated in FIG. 1-2H, the Box layer (SiO₂) 111 and the insulating layer (SiO₂) 113b are subjected to etching (S107). As the etching of the Box layer (SiO₂) 111, 0.5% hydrofluoric acid (HF) is used to subject the Box layer (SiO₂) 111 to selective wet etching. In order to subject the Box layer (SiO₂) 111 to selective etching, an aqueous solution containing fluorine ion may be used, such as, other than hydrofluoric acid, an ammonium fluoride (NH₄F) aqueous solution and a mixture of hydrogen fluoride and hydrogen peroxide.

Next, as illustrated in FIG. 1-2I, the first substrate 109 formed until S107 and a second substrate 116 are bonded to each other (S108). The second substrate 116 is an SOI substrate (SOI wafer). The SOI substrate includes a handle layer (Si) 117 having a thickness of 525 μm, a Box layer (SiO₂) 118 having a thickness of 1 μm, and an SOI layer (Si) 119 having a thickness of 1 μm. On the front surface of the second substrate 116, silicon oxide is formed by thermal oxidation as an insulating layer (not shown). After that, a resist pattern (not shown) is formed and wet etching exemplified in S107 is performed, to thereby pattern the insulating layer. Then, on the SOI layer 119 side of the second substrate 116, by plasma etching using a resist pattern (not shown) and a fluorocarbon gas exemplified in S102, a post 120 serving as a bonding portion is formed. In this embodiment, the first substrate 109 and the second substrate 116 are subjected to fusion bonding of silicon to silicon (Si—Si), but fusion bonding of silicon oxide to silicon oxide (SiO₂—SiO₂), or fusion bonding of silicon to silicon oxide (Si—SiO₂) may be used instead. Fusion bonding has advantages in that high positional accuracy of bonding can be obtained in the direction normal to the upper surface of the support member, which is the moving direction of the movable member 106, and in that other members are unnecessary.

Next, as illustrated in FIG. 1-2J, the handle layer (Si layer) 117 and the Box layer (SiO₂) 118 of the second substrate 116 are subjected to selective etching (S109). In order to subject the handle layer (Si) 117 to selective etching, chemical liquid such as tetramethylammonium hydroxide aqueous solution (TMAH) and potassium hydroxide (KOH) may be used. In order to subject the exposed Box layer (SiO₂) 118 to selective etching, wet etching exemplified in S107 may be used. With this step, the SOI layer (Si) 119 is exposed such that the SOI layer (Si) 119 becomes the reflecting member 103, and thus the variable shape mirror 101 is formed.

In the method of manufacturing the variable shape mirror 101 of this embodiment as described above, after the comb-drive actuator portion 102 is constructed of the first substrate 109, the first substrate 109 and the second substrate 116 are bonded to each other. Therefore, in the manufacturing method of the present invention, because the first substrate and the second substrate are bonded to each other after the comb-drive actuator is constructed of the first substrate, the gap between the comb electrodes can be narrowed regardless of the moving amount of the movable comb electrode. Therefore, a large moving amount can be obtained with a small drive voltage. Further, in the case of the method of manufacturing a variable shape mirror, it is unnecessary to form a mirror layer on a sacrificial layer, and hence it is possible to provide a variable shape mirror having high mirror flatness. Further, the first substrate and the second substrate are bonded to each other at a plane of the movable portion, which can be formed relatively wide and with sufficient strength. Therefore, the bonding can be stably and reliably performed without wobbling.

### Second Embodiment

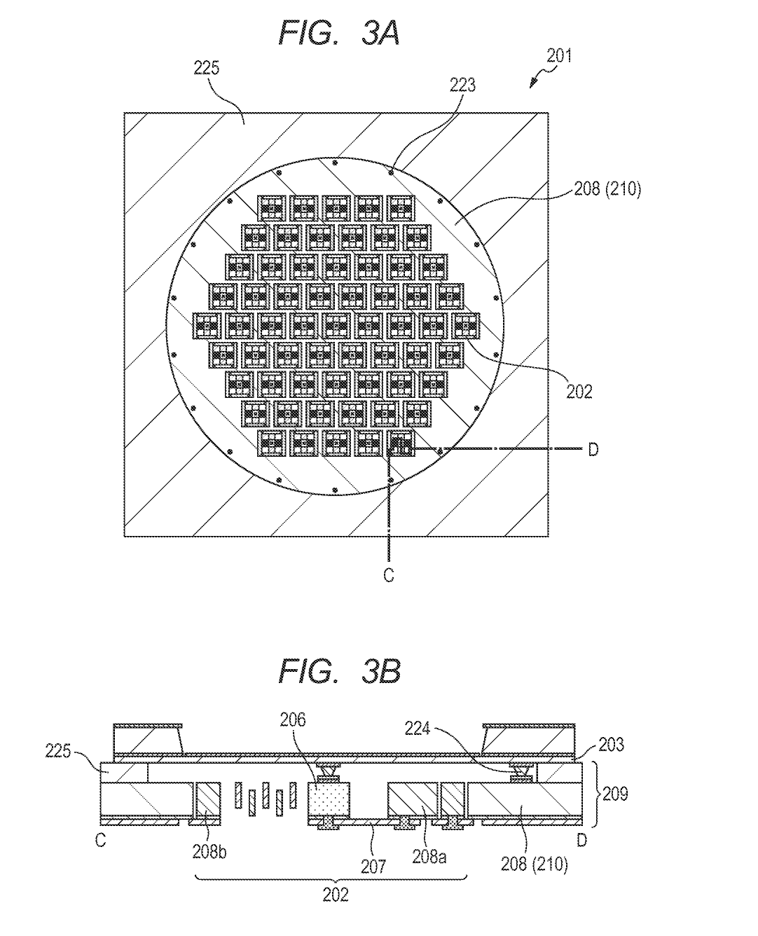

A method of manufacturing a variable shape mirror according to a second embodiment of the present invention is described with reference to FIGS. 2-1A to 2-1E, FIGS. 2-2F to 2-2K, and FIGS. 3A and 3B. FIG. 3A is a plan view of a variable shape mirror 201 manufactured by the manufacturing method according to this embodiment as viewed from a reflecting member 203 side. Note that, in order to illustrate the structure of an actuator portion 202 and the like, illustration of the reflecting member 203 is omitted. FIG. 3B is a sectional view taken along the line C-D of FIG. 3A. FIG. 2-1A is a plan view of one of multiple actuator portions 202 arranged in the variable shape mirror 201 as viewed from the surface on the opposite side to the reflecting member 203, and FIGS. 2-1B to 2-1E and FIGS. 2-2F to 2-2K illustrate manufacturing steps therefor by means of sectional views taken along the line A-B of FIG. 2-1A.

The variable shape mirror 201 according to this embodiment includes, as illustrated in FIGS. 3A and 3B, the multiple actuator portions 202 and the reflecting member 203. The structure of each of the actuator portions 202 is similar to that in the first embodiment. The reflecting member 203 is connected to a movable member 206 of each of the actuator portions 202, and is connected to a support member 208 around a region in which the multiple actuator portions 102 are provided.

Further, this embodiment differs from the method of manufacturing a variable shape mirror according to the first embodiment in that a first substrate 209 and a second substrate 217 are bonded to each other by bump bonding. Bump bonding refers to a method of adhering two substrates by providing a bump on a pad provided on one of the substrates, bringing the bump into contact with a pad provided on the other substrate, and applying a load while applying heat. Simultaneously when the bump is plastically-deformed by the load, recrystallization phenomenon is caused between the pad and the bump by the heating. Thus, the contact interface between the pad and the bump eliminates such that a strong bonding force can be obtained.

Under a state in which none of the movable members 206 is displaced (none of the movable members 206 is deformed), it is desired that the reflecting member 203 maintain a contact distance with respect to the movable member 206 of each of the actuator portions 202, and have a flat surface that is parallel to the support member 208. Therefore, in this embodiment, a distance defining member 225 is provided around the region in which the multiple actuator portions 102 are provided so as to define the plastic deformation amount of the pad during bump bonding, thereby maintaining a constant distance between the support member 208 and the reflecting member 203. Note that, when the load amount and the in-plane fluctuations of the load can be controlled at high accuracy, it is possible to omit the distance defining member 225.

Focusing on points that are different from the first embodiment, the method of manufacturing a variable shape mirror according to this embodiment is described. As for the steps not described in detail or whose description is omitted, a method similar to that in the first embodiment can be adopted. The same members as those in the first embodiment or members corresponding to those in the first embodiment are denoted by reference symbols having the same last two digits. First, similarly to the first embodiment, an SOI substrate is prepared as the first substrate 209 (S201), and as illustrated in FIG. 2-1C, the patterns of insulating layers 213 are formed on both surfaces of the first substrate 209 (S202). FIGS. 2-1A to 2-1E and FIGS. 2-2F to 2-2K illustrate only one actuator portion 202. Therefore, on the first substrate 209, the patterns and structures as illustrated in FIGS. 2-1A to 2-1E and FIGS. 2-2F to 2-2K may be formed in the number of the actuator portions 202 to be formed.

Subsequently, similarly to the first embodiment, as illustrated in FIG. 2-1D, through electrodes 214 are formed (S203). Next, as illustrated in FIG. 2-1E, pads 215 for bump bonding are formed (S204). On the front surface of the first substrate 209, films of titanium (Ti) and gold (Au) as pad materials are laminated in the stated order, and then a resist pattern (not shown) is formed. With use of the resist pattern (not shown) as a mask, gold (Au) and titanium (Ti) are subjected to etching. The pads 215 are provided not only on the movable member 206 but also around the region in which the multiple actuator portions 202 are provided at constant intervals.

Next, with use of the method similar to that in the first embodiment, as illustrated in FIGS. 2-2F and 2-2G, a movable comb electrode 204 and a fixed comb electrode 205 are formed from the front surface of the first substrate 209 (S205, S206), and as illustrated in FIGS. 2-2H and 2-2I, level differences of the comb teeth are formed (S207, S208).

Next, as illustrated in FIG. 2-2J, the first substrate 209 formed until S208 and the second substrate 217 are subjected to gold (Au) bump bonding (S209). First, an SOI substrate having a structure similar to that in the first embodiment is prepared as the second substrate 217, and on a surface of a handle layer 218 of the second substrate 217, a pattern of an insulating layer (not shown) made up of silicon oxide is formed by thermal oxidation. Subsequently, in order to form pads 222 for providing gold (Au) bumps on a surface of an SOI layer 220 of the second substrate 217, films of titanium (Ti) and gold (Au) are laminated in the stated order, and then a resist pattern (not shown) is formed. With use of the resist pattern (not shown) as a mask, gold (Au) and titanium (Ti) are subjected to etching.

On the pads 222 formed on the second substrate 217, gold (Au) bumps 223 and 224 are formed as posts.

The gold bumps 223 and 224 are formed as follows. A gold ball is formed on a leading end portion of a gold wire by discharge heating, and the gold ball is bonded onto the pad by ultrasonic assist. Then, the wire is broken, and the gold bump is formed on the pad. Bumps formed by such a method are generally called stud bumps. The diameter of the bump depends on the diameter of the gold wire. When fine bumps are desired to be formed, a thinner gold wire may be used.

The method of forming a gold bump is not limited thereto, and plating may be used instead. In a case where plating is used, the gold bump is formed as follows. First, a resist having a thickness corresponding to the height of the bump is formed on the pad 222, and after the resist is patterned into a shape of the bump by photolithography, an Au film is formed by plating. Then, the plated film is polished to have a constant height, and then the resist is removed.

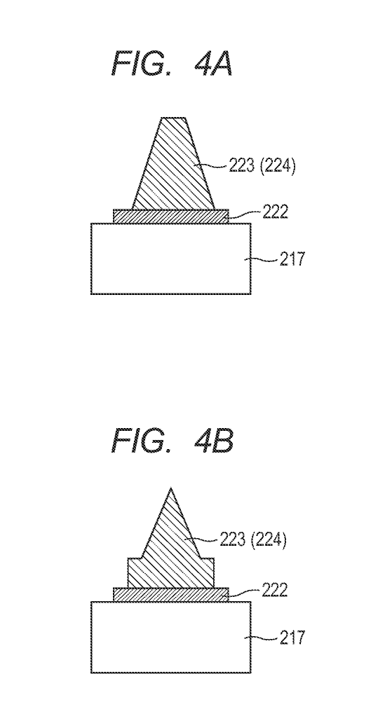

The shape of the gold bump may be a cylindrical shape or a polygonal column. It is preferred that the gold bump have a shape whose diameter on the side to be bonded to the first substrate 209 is smaller than the diameter on the second substrate 217 side. FIGS. 4A and 4B illustrate examples of cross sections of a gold bump, which are taken along a plane perpendicular to a surface of the second substrate 217 on which the pad 222 is formed. When the diameter on the side to be bonded to the first substrate 209 is smaller as in those cases, bonding can be performed by causing plastic deformation at a portion bonded to the first substrate 209 with a small load applied between the first substrate 209 and the second substrate 217. Therefore, it is possible to reduce the load to be applied to the actuator during bonding. The shape of FIG. 4B is a pedestal in which the part near the pad 222 has a cylindrical shape. With this shape, the pedestal part does not crush by the load for plastic deformation of the portion to be bonded to the first substrate 209. Therefore, between the movable member 206 and the second substrate 217, a constant gap corresponding to the height of the pedestal part can be easily maintained, which is preferred. The shape of FIG. 4B can be easily realized by employing the gold stud bump.

Next, the gold (Au) bump 223 of the second substrate 217 and the pad 215 of the first substrate 209 are accurately aligned, and heat and load are applied for bump bonding. At this time, the distance defining member 225 for defining the distance between the movable member 206 and the reflecting member 203 is arranged outside with respect to the pads provided around the region in which the multiple actuator portions 202 are provided. As the distance defining member 225, an insulating material such as quartz and silicon is preferred. As illustrated in FIGS. 3A and 3B, a member different from the first substrate 209 may be used as the distance defining member 225. Alternatively, the distance defining member 225 may be formed by processing a handle layer 210 of the first substrate 209.

The shape of the distance defining member 225 is not particularly limited as long as the distance between the movable member 206 and the reflecting member 203 can be defined. Note that, when the distance defining member 225 employs such a structure that continuously surrounds the region in which the multiple actuator portions 202 are arranged as illustrated in FIGS. 3A and 3B, it is possible to suppress entrance of particles from the outside into the actuator portions 202, and hence the reliability of the variable shape mirror can be increased, which is preferred.

Next, similarly to the first embodiment, as illustrated in FIG. 2-2K, the handle layer (Si layer) 218 and a Box layer (SiO₂) 219 of the second substrate 217 are subjected to selective etching (S210). With this step, the SOI layer (Si) 220 is exposed, and the SOI layer (Si) 220 becomes the reflecting member 203. Thus, the variable shape mirror 201 is formed.

Also in the method of manufacturing the variable shape mirror 201 of this embodiment as described above, after the comb-drive actuator portion 202 is constructed of the first substrate 209, the first substrate 209 and the second substrate 217 are bonded to each other. Therefore, the above-mentioned effect of the invention can be obtained. Further, the bump is formed on the second substrate 217, and hence it is unnecessary to form the post by subjecting the SOI layer (Si) 220 of the second substrate 217 to etching unlike the first embodiment. Therefore, it is possible to obtain such an effect that the thickness fluctuations of the reflecting member 203 to be formed can be suppressed.

Note that, in this embodiment, the gold bump is provided on the second substrate 217 side, and then the gold bump is bonded to the first substrate 209, but the gold bump may be provided on the first substrate 209 side, and then the gold bump may be bonded to the second substrate 217. In this case, it is preferred that the bump have such a shape that the diameter on the side to be bonded to the second substrate 217 is smaller than the diameter on the first substrate 209 side. However, the formation is easier in a case where the gold bump is provided on the substrate which is not subjected to micro processing, that is, on the second substrate 217.

Further, in this embodiment, gold bump bonding is performed, but instead of bump bonding, bonding using, for example, a thermosetting adhesive having a small thermal contraction, such as an epoxy resin, may be employed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-245862, filed Nov. 7, 2012, and Japanese Patent Application No. 2012-248937, filed Nov. 13, 2012, which are hereby incorporated by reference herein in their entirety.

What is claimed is:

1. A method of manufacturing a variable shape mirror including:
a support member;
a fixed comb electrode that is supported by the support member and extends in a direction parallel to an upper surface of the support member;
a reflecting member having one surface as a reflecting surface;
a movable member connected to a surface of the reflecting member on an opposite side to the reflecting surface;
an elastic member for connecting the movable member and the support member; and
a movable comb electrode that is supported by the movable member and extends in the direction parallel to the upper surface of the support member, the movable comb electrode being arranged so as to engage with the fixed comb electrode with a gap therebetween,
a part of the movable member, which supports the movable comb electrode, and a part of the support member, which supports the fixed comb electrode, being arranged such that the movable comb electrode and the fixed comb electrode pass each other while maintaining the gap when the movable comb electrode is displaced in a direction normal to the upper surface of the support member,
the method comprising:
forming, in a first substrate, the movable member, the movable comb electrode, the elastic member, the support member, and the fixed comb electrode;
preparing a second substrate;
bonding the movable member of the first substrate and the second substrate to each other; and
processing the bonded second substrate to form the reflecting member.

2. The method of manufacturing a variable shape mirror according to claim 1,
wherein the second substrate used in the bonding the movable member of the first substrate and the second substrate to each other is an SOI wafer, and
wherein the forming of the reflecting member comprises removing a handle layer and a Box layer of the SOI wafer.

3. The method of manufacturing a variable shape mirror according to claim 1, wherein the bonding the movable member of the first substrate and the second substrate to each other comprises fusion bonding.

4. The method of manufacturing a variable shape mirror according to claim 1, wherein the bonding the movable member of the first substrate and the second substrate to each other comprises bump bonding.

5. The method of manufacturing a variable shape mirror according to claim 1, wherein the bonding the movable member of the first substrate and the second substrate to each other comprises bonding using an adhesive.

6. The method of manufacturing a variable shape mirror according to claim 1, further comprising subjecting the first substrate to etching to simultaneously form the fixed comb electrode and the movable comb electrode.

7. The method of manufacturing a variable shape mirror according to claim 1, further comprising forming, between the fixed comb electrode and the movable comb electrode, a level difference in the direction normal to the upper surface of the support member.

8. The method of manufacturing a variable shape mirror according to claim 1, further comprising forming, on the movable member of the first substrate, a post to be bonded to the second substrate.

9. The method of manufacturing a variable shape mirror according to claim 1, further comprising forming, on the second substrate, a post to be bonded to the movable member of the first substrate.

10. The method of manufacturing a variable shape mirror according to claim 1, wherein the bonding the movable member of the first substrate and the second substrate to each other comprises arranging, between the first substrate and the second substrate, a distance defining member for defining a distance between the first substrate and the second substrate.

11. The method of manufacturing a variable shape mirror according to claim 8,
wherein the forming, on the movable member of the first substrate, a post to be bonded to the second substrate comprises forming a bump on the movable member of the first substrate, and
wherein the bump is formed such that a diameter on a side to be bonded to the second substrate is smaller than a diameter on the first substrate side.

12. The method of manufacturing a variable shape mirror according to claim 9,
wherein the forming, on the second substrate, a post to be bonded to the movable member of the first substrate comprises forming a bump on the second substrate, and
wherein the bump is formed such that a diameter on a side to be bonded to the first substrate is smaller than a diameter on the second substrate side.

13. A method of manufacturing a micro structure including:
a membrane;
a movable portion connected to the membrane;
a movable comb electrode that is located with a distance with respect to the membrane and supported by the movable portion, the movable comb electrode extending in a direction parallel to a surface of the membrane;
a suppressing unit for suppressing displacement of the movable comb electrode and the movable portion in a direction other than a direction normal to the surface of the membrane;
a support portion; and
a fixed comb electrode that is supported by the support portion and extends in the direction parallel to the surface of the membrane, the fixed comb electrode being alternately arranged with respect to the movable comb electrode with a gap therebetween,
a part of the movable portion, which supports the movable comb electrode, and a part of the support portion, which supports the fixed comb electrode, being arranged such that the movable comb electrode and the fixed comb electrode pass each other while maintaining the gap when the movable comb electrode is displaced in the direction normal to the surface of the membrane,
the method comprising:
forming, in a first substrate, the movable portion, the movable comb electrode, the suppressing unit, the support portion, and the fixed comb electrode;
preparing a second substrate;
bonding the movable portion of the first substrate and the second substrate to each other; and
processing the bonded second substrate to form the membrane.

14. A variable shape mirror, comprising:
a support member on which multiple actuator portions are arranged;
a reflecting member bonded to the multiple actuator portions by bumps; and
a distance defining member for defining a distance between the support member and the reflecting member, the distance defining member being arranged between the support member and the reflecting member and around a region in which the multiple actuator portions are arranged.

15. The variable shape mirror according to claim 14, wherein the distance defining member continuously surrounds the region in which the multiple actuator portions are arranged.
